(19) United States
(12) Patent Application Publication
(10) Pub. No.: US 2011/0297749 A1
(43) Pub. Date: Dec. 8, 2011

(54) VERIFIABLE SYMBOLIC DIRECT PART MARK AND METHOD OF ITS FABRICATION

(75) Inventors: Alexey V. LEZHNEV, Moscow (RU); Dmitry V. PEBALK, Moscow (RU); Michail U. KVASHA, Moscow (RU); Kirill I. DONETSKY, Moscow (RU); Galina N. DOROZHKINA, Moscow region (RU); Iosif E. DISKIN, Moscow (RU)

(73) Assignee: LLC FLUORESCENT INFORMATION TECHNOLOGY, Moscow (RU)

(21) Appl. No.: 12/968,305

(22) Filed: Dec. 15, 2010

(30) Foreign Application Priority Data
Jun. 5, 2010 (RU) 2010127357

(51) Int. Cl. G06K 19/06; B05D 3/12; G06K 19/02

(52) U.S. Cl. 235/488; 235/489; 427/290

(57) ABSTRACT

Direct application symbol mark which consists of information elements which are formed in needle-impact marking on the surface of the part being marked in the form of conical depressions and which are filled with paint, characterized in that an adhesively fixed film with the recorded optical information with perforated openings which coincide with the depressions is located overhead on this surface, and the paint which is used for filling is fluorescent.

### OBJECT OF THE INVENTION

This invention relates to a field of development of optical and optoelectronic means of marking, analog-digital encoding and decoding of various objects and parts. More specifically it relates to methods and systems of application of information marks directly to the object which is being marked—direct application symbol marks SMPN (“Direct part marking”—DPM). The object of the invention is to increase the noise immunity of information by verifying the genuineness of the SMPN which has been applied to the object. Here the primary element which ensures high reliability of protecting the genuineness of the SMPN is the use of protective, multilayer information marks applied over the SMPN, and the use of contrasting coloration by means of luminophores.

### TECHNICAL LEVEL OF THE INVENTION

Technologies of so-called direct application symbol marks (SMPN—“Direct Part Marking”—DPM) which contain the necessary information about the item in coded form have become more and more widely used in the last several years in Europe and the US in a number of branches of industry which are characterized by increased demands for accounting, quality and reliability of parts, assemblies and articles. SMPN is a versatile means for automatic data collection and protection of output both in the process of production and in operation. In contrast to ordinary symbol marks which are printed on a paper or a plastic medium and which are then cemented onto the object being monitored, SMPN are applied directly to the surface of the article and can only be removed together with the material of this surface, thus its being a reliable method of tracking and monitoring the life cycle of the object up to its recycling.

Identification of a SMPN on an object (article, output, etc.) includes two stages—application of the marking in the form of a bar code (one-dimensional or two-dimensional) and its reading.

Currently there are several methods of applying SMPN, the equipment for which is available on the market—needle impact application, laser (several types) application, electrochemical etching and application of paint using droplet jet printing.

Droplet jet marking is based on the application of ink droplets of very small diameter to given points of the surface of the moving material, thus forming the required pattern. This technology is relatively highly productive, but the resistance of the inks to unfavorable factors (abrasive action, temperature, climatic factors) is not adequate for prolonged and reliable preservation of information. Besides droplet jet marking, thermotransfer printing is also used; it has the same defects.

In droplet jet marking (thermotransfer printing) the paint lies on the surface of the object. In the other methods examined below marking is done by forming depressions on the surface of the object.

Laser marking (engraving) is based on the change of the color of the surface of the article under the action of a laser beam. This method has high productivity in concert with relative resistance to unfavorable effects (abrasive and temperature effects). The technology of electrochemical etching is based on the action of chemical reagents on individual sections which are free of protection on the surface of the material. The main condition for use of this type of marking is the electrical conductivity of the material which is being marked (metals). With its low productivity this technology can also ensure high indicators for resistance of marking.

Needle impact marking is of considerable interest; it is based on the mechanical action of a sharp needle on the surface of the material; here depressions are made in the form of conical craters which form a given image. This method makes it possible to obtain marking with high resistance to abrasive and chemical action, and also extreme temperatures and climatic factors. The defect of this method of marking is the necessity of using special conditions of illumination to obtain high-contrast images on the surface.

In the application of SMPN, mainly two-dimensional coding (2D-coding) which has a high information capacity and noise immunity is used. The main difference of the two-dimensional code consists in that two orthogonal directions on the plane, vertical and horizontal, are used to store information. As a result, in terms of the volume of information being stored, the capacity of a two-dimensional code can exceed the capacity of a one-dimensional code by hundreds of times (for example, it can store several pages of text). If an external computer database is necessary in working with one-dimensional code, in many cases the use of a two-dimensional code makes it possible to forgo this database since the code capacity is sufficient for storage of complete information about the object. Herein lies the qualitative difference of the two technologies.

For this reason two-dimensional codes are irreplaceable, for example in self-contained identification systems or if it is necessary to store complex characters of languages such as Japanese or Chinese. Moreover essentially all modern technologies of two-dimensional codes in contrast to one-dimensional codes contain error correction means, generally based on the Reed-Solomon algorithm or other similar algorithms, and consequently ensure greater reliability of data protection.

2D bar codes are essentially portable information files of high density and capacity and ensure access to large volumes of information without references to an external database. That is, the technology of 2D bar coding makes it possible to store all or a large part of the necessary information in the bar code itself. 2D bar codes have predominantly a matrix form and do not use traditional bars/gaps for coding of information. Instead of a standard technology of determining the width of the bar, matrix bar codes use constructions of the “yes-no” or “one-zero” type (i.e. “on/off” -design) for encoding of information. There is a large number of varieties of 2D bar codes (for example PDF417, MaxiCode, Datamatrix).

The structure of the code supports coding of a maximum number from 1000 to 2000 symbols in one code at an information density from 100 to 340 symbols. Each code contains a start and finish group of bars which increase the height of the bar code.

2D bar code readers, in contrast to ordinary bar code scanners, first capture their picture, then analyze the image obtained, and only then extract the bar code from it and decode it. Devices which use video image analysis are necessary for effective reading of matrix codes, but they can also read ordinary bar codes. The technology of video image analysis opens possibilities for reading of inscriptions, optical symbol recognition, etc.

Actually, in terms of the data volumes which can be supported and the functional capabilities, the technology of two-dimensional coding is intermediate between the technologies of one-dimensional bar codes and remote identification.

Initially two-dimensional codes were developed for applications which do not provide space sufficient for accommodating an ordinary bar code identifier.

The first application for these symbols was packages of pharmaceutical preparations in health care. These packages are small in dimensions and have little room for 1D symbols. The electronics industry is also evincing interest in high density codes and two-dimensional codes in conjunction with the reduction of the dimensions of components and articles.

One of the problems of reading and decoding of SMPN is associated with major technological difficulties both in hardware and software. For a scanner which is used for reading SMPN the main problem consists in producing the illumination of the mark on a random surface which is necessary for obtaining an image of the quality which is required for reliable recognition. In the software the problem consists in increasing the decoding capacity of analysis of heterogenous “diffuse” images. Here the strong relationship between the electronic image obtained and the state of the surface and external illumination has a major effect on the decoding process.

Another problem is the verification of the genuineness of the applied SMPN on the surface of the object per se. Due to the development and the accessibility of industrially produced devices for applying SMPN using the needle impact method, and also means of decoding information, special means are required for protection against unauthorized marking of counterfeit output. This is especially important at the stage of delivery of the output from the producer to the consumer. At this stage the probability of introduction of counterfeit output into the delivery chain is great even under the condition of using a direct application symbol mark which in turn can be falsified. That is, a combination of the high information capacity of the SMPN with two-dimensional encoding and the limitation of the possibility of its unauthorized application to the surface of the object is necessary. It is important not only to mark output with recording of information which is preserved unaltered throughout operation, but also to have information and additional evidence that output which has arrived from the producer is not counterfeit. Here information about marking applied to the output can be recorded on a data medium which ensures preservation of these data during the time of delivery of the output from the producer to the consumer and confirms the genuineness of the direct symbol marking, and consequently also the output.

To effectively solve these problems, a new verifiable SMPN (VSMPN) is proposed which consists of part of the surface of the object with encoded information in the form of depressions which are located on the surface and which are filled with contrasting fluorescent dye and/or with several fluorescent dyes and/or mixtures of them, and over which a mark is applied which is mechanically (adhesively) coupled to it and which has a number of protective features with the recorded optical information, in the form of a polymer film, including a multilayer film, with perforated openings. During the reading of SMPN information this construction not only ensures high contrast, which is independent of roughness, color and illumination of the surface of the object, but also allows verification of the SMPN itself.

A design proposed in [U.S. Pat. No. 7,028,901] is known, where to improve reading of the direct application symbol mark which has been obtained in needle-impact marking, it is suggested that reading be done at different angles of incidence of the radiation onto the marked surface. But it does not completely solve the problem of increasing the contrast and dependency of the image on the optical properties of the surface, especially in the case of the presence of optical heterogeneities which are similar in dimensions to the information elements of the SMPN. Moreover the construction of the mark does not provide for the verification of its genuineness.

A similar approach is proposed in [U.S. Pat. No. 7,131,587], where to improve reading of the mark, it is proposed that the mark be irradiated at various angles of incidence of the radiation on the surface being read, but in addition the use of various wavelengths of radiation for this purpose is also proposed. But it does not entirely solve the problem of increasing the contrast and the relationship between the quality of image and the optical properties of the surface, especially in the case of the presence of optical heterogeneities which are similar in dimensions to the information elements of the SMPN. Moreover the construction of the mark does not provide for the verification of its genuineness.

A design is known in which for contrasting of symbol marks which have been formed using the needle impact method it is suggested that their depressions be filled with paint (A F Schramm, D. Roxby, Beginning the 21st century with advanced automatic parts identification, http://ntrs.nasa.gov/archive/nasa/casi.ntrs.nasa.gov/19940027938_{—}1994027938.pdf). But the readability of these marks depends on the quality of the surface. Moreover neither the construction of the mark nor the construction of the reading device provides for verification of the mark.

A similar approach is also described in the presentation of Sabreen Group, Inc [D. Roxby, J, Hornkohl http://www.sabreen.com/laser_marking_harsh_environments.htm] and is mentioned in patent U.S. Pat. No. 6,533,181 B1 (D.Roxby, S. Mann, issued Mar. 18, 2003).

A similar approach is suggested in http://www.robins.af.mil/shared/media/document/AFD-091005-065.pdf), where in order to increase contrast it is proposed that the depressions of the symbol mark be filled with paint. But, as in the previous case, the readability of these marks depends on the surface quality. Moreover neither the construction of the mark nor the construction of the reading device provides for verification of the mark.

A similar approach is contained in the General Electric Inc. presentation [“AIM DPM Verification of Dot Peen Data Matrix Symbols on Small Curved Surfaces” by Ron Page http://www.ndia.org/Divisions/AdHocWorkingGroups/UIDIndustryLeadershipAdvisoryGroup/Doc uments/GE_AVN_DPM_Verification.pdf], where it is proposed that the dimples of the needle impact mark be filled with black or white paint to improve the image quality. But this method does not reduce the effect of external illumination and does not significantly increase the contrast. Moreover neither the construction of the mark nor the construction of the reading device provides for verification of the mark.

A design suggested in application US 2005/0180804 is also known which describes a system for direct marking and verification of a mark using a bar code scanner and computer analysis. But these marks have low contrast which depends on the quality of the surface; this makes it difficult to read the information

### DISCLOSURE OF THE INVENTION

The above described and other problems are solved using methods and devices according to the examples described below in this invention.

The object of this invention is to devise a verifiable direct application symbol mark (VSMPN) and methods of its production by applying and fixing on the surface of the symbol mark a protective mark with optical information which is a perforated film, including a multilayer film, such that the depressions of the information elements of the symbol mark on the surface and the perforated openings of the protective mark coincide with one another and are filled with fluorescent paint.

The subject matter of the invention is a verifiable direct application symbol mark (SMPN) which consists of information elements formed on the surface of the part being marked in the form of conical depressions in needle impact marking of the surface with a protective mark in the form of a perforated polymer film fixed beforehand on the surface with recorded optical information, which is characterized in that the information elements of the symbol mark and the perforated openings of the protective mark are formed at the same time in needle impact marking, coincide with one another, and are filled with a fluorescent paint which absorbs radiation at the wavelengths of the near UV, visible and near IR ranges.

The construction of the verifiable SMPN ensures its elements are connected such that in an unauthorized attempt to separate the mark from the surface the fluorescent filling of the openings and depressions will be completely or partially destroyed or they will be displaced relative to one another, in particular in an attempt to apply another protective mark; this makes it impossible to correctly read and decode all the optical information.

To fill the depressions on the surface of the object and the perforated openings in the film with the optical information, the use of fluorescent paints is proposed which absorb radiation at wavelengths of the near UV, visible and near IR ranges and which are characterized in that they absorb radiation predominantly either up to the short-wave transmission edge of the filter of the reading device in the 250-600 nm range, and radiate in the wavelength range of the passband of the receiving channel of the reading device primarily 600-700 nm, or absorb radiation at wavelengths greater than the long-wave transmission edge of the filter of the reading device, predominantly in the 700 nm-10 micron range, and radiate in the wavelength range of the passband of the input filter of the reading device, predominantly 600-700 nm.

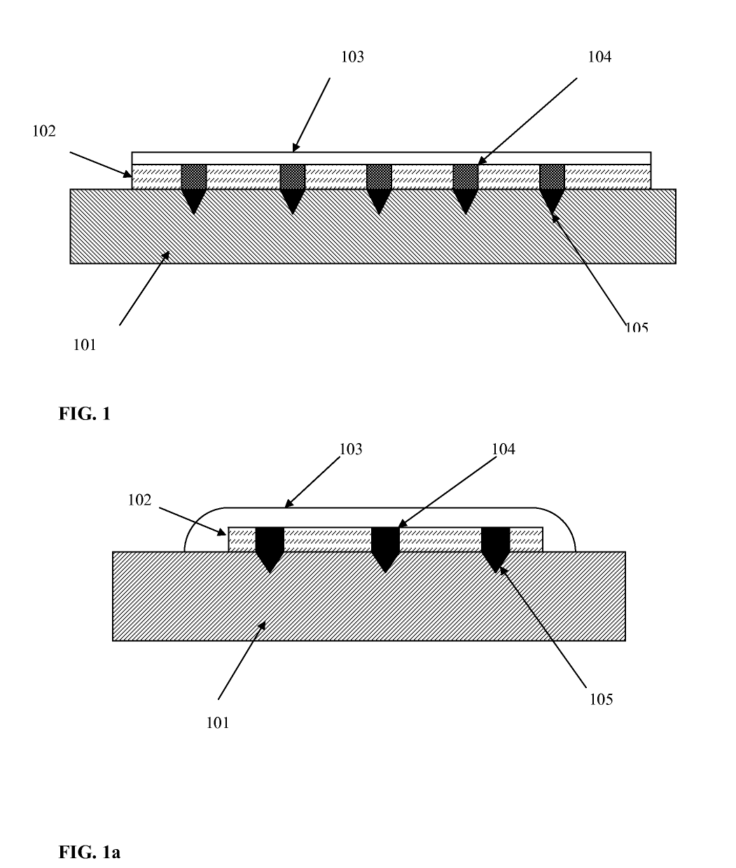

The essence of the proposed technical approach is explained using FIGS. 1-8.

FIG. 1 shows a general view of the verifiable direct application fluorescent symbol mark with a protector film.

FIG. 1a shows a general view of the verifiable direct application symbol mark with a protector lacquer film.

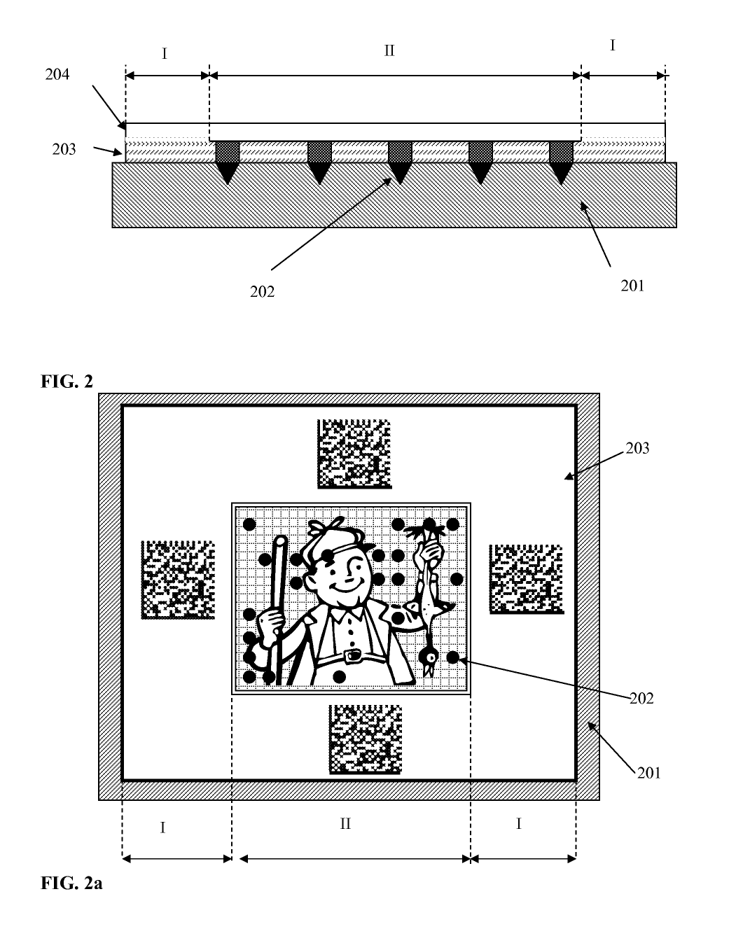

FIG. 2 shows the verifiable direct application symbol mark with analog and digital information on the protective mark.

FIG. 2a shows a top view of the verifiable direct application symbol mark on a film with analog and digital optical information.

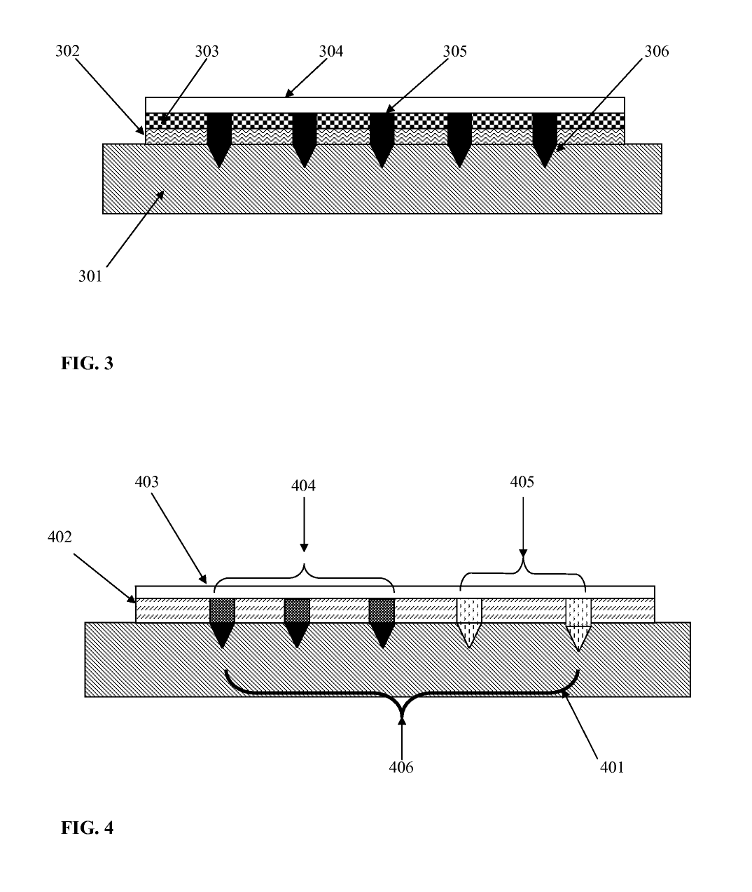

FIG. 3 shows the verifiable direct application symbol mark with a multilayer film with optical information recorded on each layer, and with depressions and perforated openings filled with fluorescent paint.

FIG. 4 shows a direct application symbol mark with filling of the perforated openings in the film and depressions on the surface using two fluorescent dyes.

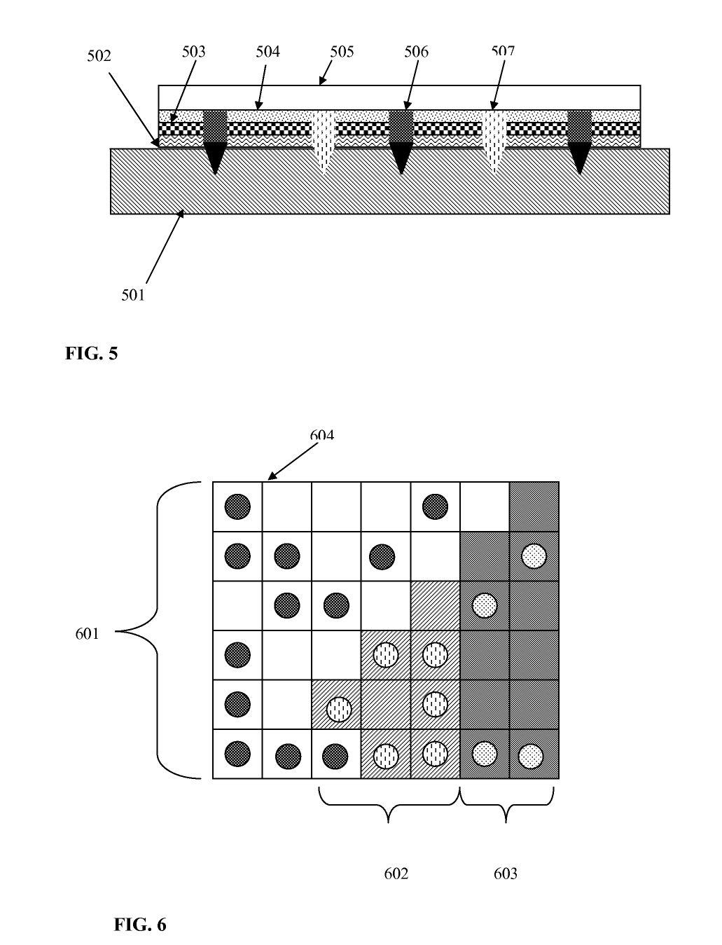

FIG. 5 shows a direct application symbol mark with a multilayer film with optical information recorded on each layer, with filling of the perforated openings in the film and depressions on the surface using two fluorescent dyes.

FIG. 6 shows a top view of the verifiable direct application symbol mark with filling of the openings and depressions using three fluorescent dyes.

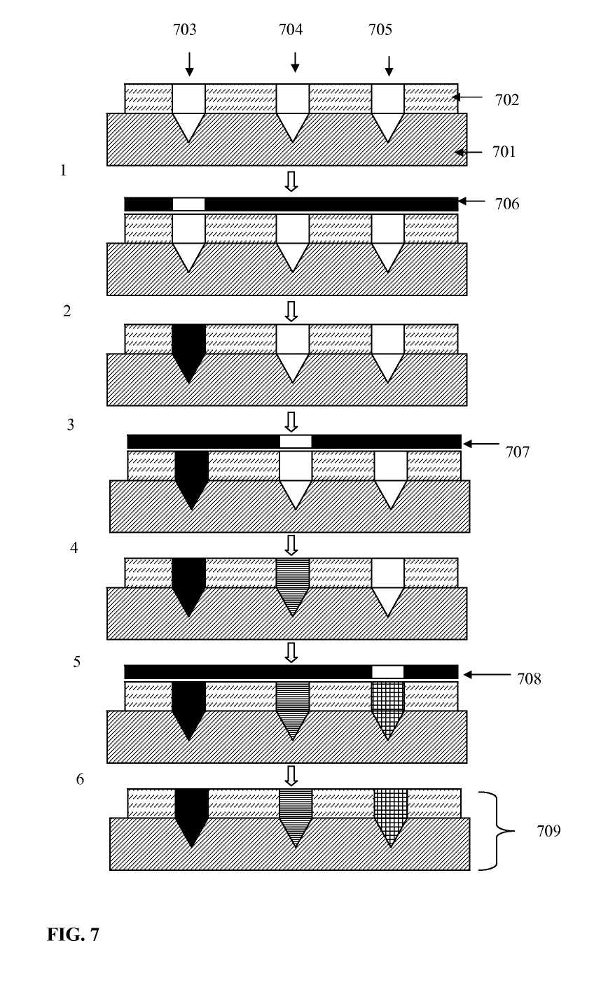

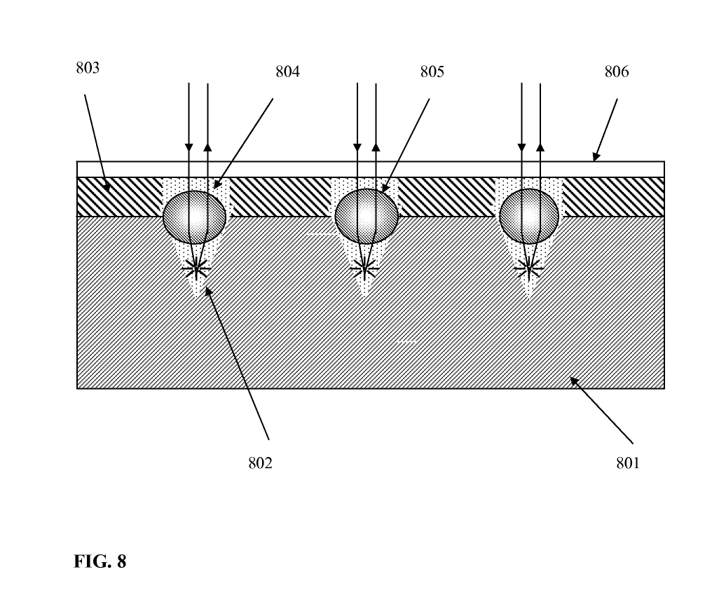

FIG. 7 shows the method of filling the perforated openings in a film with recorded optical information and depressions on the surface using three fluorescent dyes.

FIG. 8 shows the verifiable direct application symbol mark with filling of the perforated openings and depressions using a fluorescent dye with retro-reflective beads.

### DISCLOSURE OF THE INVENTION

A verifiable direct application symbol mark (VSMPN) is the surface of an object on which a protective mark is fixed (cemented) in the form of a film with recorded optical information, which mark is marked using the needle impact method in such a way that conical depressions form on the surface, but in the film at the same time through openings which coincide with them are perforated. The depressions and openings are filled with fluorescent paint. FIG. 1 schematically shows the construction of the VSMPN. On the surface of the object 101 there is a protective mark 102 which is a film with the recorded optical information. The film is fixed (cemented) on the surface of the object using an adhesion layer which is located between the touching surfaces of the object and the film. The adhesion layer is not shown in FIG. 1. With needle-impact marking on the surface of the object conical depressions 105 and perforated through openings are formed in the film 104 and are filled with quick hardening fluorescent paint with a certain absorption and emission spectrum. The paint can completely or only partially fill the perforated openings. The use of fluorescent paints is preferable which absorb excitation radiation at wavelengths of the near UV, visible and near IR ranges, which absorb radiation predominantly either up to the short-wave transmission edge of the filter of the reading device in the 250-600 nm range, and which radiate in the wavelength range of the passband of the receiving channel of the reading device primarily 600-700 nm, or which absorb radiation at wavelengths greater than the long-wave transmission edge of the filter of the reading device, predominantly in the 700 nm-10 micron range, and which radiate in the wavelength range of the passband of the input filter of the reading device, predominantly 600-700 nm. The basis of the fluorescent paints is preferably the use of quick-drying lacquer solutions of polymers, or photohardenable polymer (oligomer) composition materials. An important factor is also the high adhesion to the surface of the object and the mark (film) with the optical information after hardening of the paint.

For strong preliminary fixing of the protective mark (film) 102 with the recorded information on the surface of the object 101 a transparent adhesion layer is used which has been applied beforehand to one of the surfaces of the film. To improve the adhesion of the mark (film), the surface of the object can go through special cleaning, grinding and preparation, for example by treatment with a plasma, and/or by application of primers (adhesion promoters) and other physical and chemical methods.

A protector layer 103 which is transparent to the reading radiation and the radiation being read in the form of a polymer film or lacquer coating (FIG. 1a) which protects the VSMPN from external effects is applied (cemented) from overhead to the surface of the film with the optical information

The optical information which is recorded onto the protective mark 102 can be both analog and digital. The analog information can be recorded in the form of a volumetric or relief hologram or diffraction grating structures. The analog information can also be represented by fluorescent (luminescent) images. A concealed (latent) optical anisotropic image which is formed in the layer and which is being read in polarized light, for example as described in U.S. Pat. No. 6,124,970, U.S. Pat. No. 6,740,472, RU 87658 U1, can also be used.

The method of producing the VSMPN consists in the following. A protective mark (film) with the recorded optical information can be cemented to the prepared (cleaned, degreased, ground, if necessary with primer (adhesion promotor) applied) surface of the object. Afterwards, in the region of the cemented mark, needle-impact marking is done which penetrates the film with the formation of perforated through openings and at the same time with the formation of conical depressions on the surface of the object. This results in exact coincidence of the openings on the protective mark and depressions on the surface. Since the mark with the recorded information can be prepared using certain fixed circulation and for example with an individual number, in other production with limited access and separately from the marking site, this forms protection against the possibility of uncontrolled application of a symbol mark in counterfeit production of output. After needle-impact marking the information elements consisting of depressions on the surface and openings in the film are filled with fluorescent paint. Prior to needle impact marking an auxiliary film (in this case if it has not applied beforehand prior to the operation of cementing) which plays the part of a temporary template which can be removed from the surface after the operation of applying the paint can be applied to the surface of the protective mark (film) with the optical information. Then the depressions and openings are filled with quick-hardening fluorescent paint. To do this, various methods of applying paint to the template using a brush, marker, sponge, roller, and so forth, by aerosol sputtering, powder spraying and other known methods can be employed. The depressions and openings can also be filled directly during needle-impact marking if the marker is equipped with a paint injection mechanism; in this case it is not necessary to use a temporary template. After filling the information elements with fluorescent paint and its hardening the temporary template is removed and a protector film can be cemented onto the film with the optical information from overhead or a lacquer layer which protects the VSMPN from external effects is applied.

Since, in needle-impact marking only local spot destruction of the analog optical information which has been recorded on the protective mark takes place, the integral representation of the image being visualized with characteristic details is preserved; this is the verifiable criterion of genuineness of the direct application symbol mark. On the protective mark outside the needle-impact marking region there can be additional digital information; this is shown conventionally in FIG. 2. A protective mark 203 is cemented onto the surface of the object 201. The method of needle-impact marking forms conical depressions and perforated openings which are filled with fluorescent paint 202. The protective mark has optical analog information which is recorded in region II, and optical, digital machine-readable information which is recorded in region I. A protector layer or film 204 is applied to the layer with the optical information from overhead.

FIG. 2a conventionally shows a top view of the VSMPN with the film with the recorded analog and digital information.

A protective mark which is fixed on the surface of the object can be produced using a multilayer film, on each layer of which optical information can be recorded using different methods which include methods of holography, methods of recording fluorescent and polarization images and symbols, including machine-readable ones. FIG. 3 schematically shows a construction of a VSMPN using a multilayer protective mark. A protective mark consisting of two different layers 302 and 303 with the recorded optical information is fixed on the surface of the object 301. Conical depressions 306 are formed on the surface 301 in needle-impact marking, but perforated through openings 305 filled with fluorescent paint are formed in the protective mark. The protector film 304 is located on top of the film with the recorded optical information. The layer 303 should be transparent for reading of the optical information located on the layer 302. A light-reflecting layer, for example aluminum or a material with a high index of refraction can be applied to the layer 302 which directly adjoins the surface of the object and a relief hologram or diffraction grating structure can be formed. A fluorescent (luminescent) or optically anisotropic image can be formed in the layer 303. It is understood that the protective mark which has been fixed on the surface 301 with the recorded optical information can have more than two layers, each of which can carry its own part of the information.

Additional protective measures which hinder unauthorized separation of the film with the optical information from the surface can be cutouts of the film or the joining of the layers of a multilayer film using adhesives which ensure nonuniformity of the separation of layers in tearing off, as is proposed in patent U.S. Pat. No. 6,849,149.

To verify the SMPN, more than one fluorescent paint can be used to fill the conical depressions on the surface and the perforated openings in the film with the optical information. In this case, the paints are chosen such that the fluorescence spectra do not overlap or overlap only partially. The form and kinetics of the change of the integral shape of the paint spectrum can be a “spectral signature” and are stored in a separate external database of the manufacturer, which data confirm the genuineness of the VSMPN.

FIG. 4 shows the VSMPN in whose construction two paints with different spectral-luminescent characteristics are used. A film 402 with the recorded optical information is located on the surface of the object 401. Using the method of needle-impact marking, in the surface of the object 401 conical depressions 406 are formed and at the same time in the film 402 with the recorded optical information through openings 405 are perforated, which are filled by two different fluorescent paints (I and II). The protector film 403 is applied to the film 402 from overhead.

FIG. 5 conventionally shows the construction of the VSMPN in which a multilayer film with optical information which has been recorded on each of the layers 502-504 has been applied to the surface of the object 501. Using the method of needle-impact marking on the surface 501 conical depressions are formed and at the same time in the multilayer film through openings are perforated, which are filled with three different paints with different spectral-luminescent characteristics.

The disposition of the elements which consist of conical depressions on the surface and of perforated openings in the film which are filled with paints can be different; this is conventionally shown in FIG. 6. The local coloration of the VSMPN 604 is formed by three dyes 601, 602, and 603. The order of disposition on the surface is also a verifiable criterion of the direct application symbol mark. Thus the “spectral signature”, i.e. characteristic bands of the fluorescence spectrum and the kinetics of the change of the fluorescence spectrum over time, and also the two-dimensional coordinates of the disposition of a certain spectrum on the surface are a unique verifiable criterion of the VSMPN which can be stored in the external database and used in checking the genuineness of the applied mark.

The method of producing the VSMPN with filling of the information elements with three paints is shown conventionally in FIG. 7. A template 706 (operation 1) is placed on the VSMPN which has been applied to the surface of the object 701 with the cemented film with the recorded optical information 702 and marked using the needle-impact marking (items 703-705). The template 706 covers the information elements 704 and 705; afterwards the elements 703 are filled with the first paint and the template 706 is removed (operation 2). Then the template 707 which covers the elements 703 and 705 is put in place, the elements 704 are filled with the other paint (operation 3) and the template 707 is removed (operation 4). Afterwards the template 708 which covers the elements 703 and 704 is put in place, the elements 705 are filled with a third paint (operation 5) and the template 708 is removed (operation 6). Afterwards the protector film is applied to the surface. As a result, a VSMPN is obtained with information elements which are filled with three paints with different spectral-luminescent characteristics.

An additional element which can be introduced into the construction of the VSMPN is retro-reflective beads which are located within cavities which are formed in needle-impact marking of the surface of the object with the applied film with the optical information. The retro-reflective beads which are made of optically transparent material, primarily glass, with a high index of refraction, besides the function of a verifier are also designed to enhance the fluorescent signal which is being read. FIG. 8 shows a construction of the VSMPN. A film 803, including a multilayer film, with the recorded optical information is fixed (cemented) on the surface of the object 801. Conical depressions 802 are formed on the surface 801 and perforated (through) openings 804 are formed on the film 803 using the needle-impact marking method. The conical depressions and perforated openings form cavities which are filled with fluorescent paint (or paints) which contains retro-reflective beads 805. The diameter of the beads Db is less than the diameter of the openings Dope and is preferably within Dope/2<Db<D ope. In the latter case, when filling with paint no more than one bead falls into the opening, which bead is partially located in the conical depression on the surface, and partially in the opening which has been formed in the film. The retro-reflective beads are preferably introduced directly into the composition of the fluorescent paint which fills the conical depressions and perforated openings. A protector coating 806 is applied from above the film 803. In an attempt to remove the film 803 from the surface 801 partial or complete separation of beads from the surface of the object takes place; this leads to the impossibility of correctly reading the information. Thus, the retro-reflective beads are an additional protective element of the SMPN.

1. Direct application symbol mark which consists of information elements which are formed in needle-impact marking on the surface of the part being marked in the form of conical depressions and which are filled with paint, characterized in that an adhesively fixed film with the recorded optical information with perforated openings which coincide with the depressions is located overhead on this surface, and the paint which is used for filling is fluorescent.

2. Direct application symbol mark characterized according to claim 1 in that the perforated openings in the film are filled with the same fluorescent paint as the depressions on the surface.

3. Direct application symbol mark characterized according to claim 1 in that above the film with the recorded optical information a protector film or lacquer coating which is transparent to the reading information and the information which is being read is applied.

4. Direct application symbol mark characterized according to claim 1 in that the recorded optical information on the film which is located on the surface is analog and/or digital.

5. Direct application symbol mark characterized according to claim 4 in that the digital information which has been recorded on the film is located three-dimensionally outside the region of the surface with the information elements which have been formed in needle-impact marking.

6. Direct application symbol mark characterized according to claim 4 in that the analog optical information which has been recorded on the film is a volumetric or relief hologram.

7. Direct application symbol mark characterized according to claim 4 in that the analog optical information which has been recorded on the film is a diffraction grating structure.

8. Direct application symbol mark characterized according to claim 4 in that the analog optical information which has been recorded on the film is carried out using fluorescent dyes.

9. Direct application symbol mark characterized according to claim 8 in that the emission spectra of the fluorescent dye which is used for recording of the optical information on the film and of the fluorescent paint which is used to fill the depressions on the surface and perforated openings in the film do not overlap.

10. Direct application symbol mark characterized according to claim 4 in that the analog optical information which has been recorded on the film is optically anisotropic.

11. Direct application symbol mark characterized according to claim 1 in that the film with the recorded optical information is a multilayer film.

12. Direct application symbol mark characterized according to claim 11 in that on the film layers the optical information can be recorded in the form of a volumetric or relief hologram and/or a diffraction grating structure and/or using fluorescent dyes and/or polarized optically anisotropic elements.

13. Direct application symbol mark characterized according to claim 1 in that fluorescent paints are used which absorb radiation at wavelengths of the near UV, visible and near IR ranges, predominantly either up to the short-wave transmission edge of the filter of the reading device in the 250-600 nm range, and which radiate in the wavelength range of the passband of the receiving channel of the reading device primarily 600-700 nm, or which absorb radiation at wavelengths greater than the long-wave transmission edge of the filter of the reading device, predominantly in the 700 nm-10 micron range, and which radiate in the wavelength range of the passband of the input filter of the reading device, predominantly 600-700 nm.

14. Direct application symbol mark characterized according to claim 1 in that to fill the depressions and perforated openings in the film with the recorded optical information at least two fluorescent paints are used with different spectral-luminescent characteristics and which also fill the different sets of depressions and openings accordingly.

15. Direct application symbol mark characterized according to claim 14 in that the fluorescent paints absorb the reading radiation with the same wavelength and radiate at different wavelengths.

16. Direct application symbol mark characterized according to claim 14 in that fluorescent paints absorb reading radiation at different wavelengths, and the fluorescence spectra are located in one spectral region.

17. Direct application symbol mark characterized according to claim 14 in that the spectral-luminescent characteristics of the paint and the spatial two-dimensional distribution of the depressions on the surface and perforated openings of the film with the recorded optical information which are filled with it are a verifiable identifier of the genuineness of the symbol mark.

18. Direct application symbol mark characterized according to claim 17 in that the paint contains retro-reflective beads with a diameter less than the diameter of the perforated openings in the film with the recorded optical information.

19. Direct application symbol mark characterized according to claim 18 in that the diameter of the retro-reflective beads is greater than half the diameter of the perforated openings in the film.

20. Method of producing a direct application symbol mark which includes needle-impact marking of the surface of the object with subsequent local filling of the depressions of the information elements with paint, characterized in that the film with the recorded optical information is cemented first to the surface, and the depressions on the surface are filled at the same time with filling of the openings which have been perforated in needle impact marking in the film.

21. Method of producing a direct application symbol mark which is characterized according to claim 20 in that for simultaneous filling of the depressions and openings in the film with the recorded optical information, before needle impact marking a temporary film-template is placed or cemented first onto the surface of the film with the recorded optical information and is perforated simultaneously with the film with the recorded optical information, with subsequent filling of depressions on the surface and perforated openings with paint and with subsequent removal of the temporary film-template.

22. Method of producing a direct application symbol mark which is characterized according to claim 21 in that before applying the paint, the openings which have been perforated in the temporary film-template are selectively covered by one auxiliary film, then selective filling of the open depressions and openings with one paint is done, afterwards they are covered by another auxiliary film, the first auxiliary film is removed and selective local filling of the concealed depressions and openings by another paint is done.

23. Method of producing a direct application symbol mark which is characterized according to claim 21 in that the depressions and openings in the film are filled by their alternate selective covering and concealment by templates and auxiliary films, in doing so filling being done using at least two paints.

24. Method of producing a direct application symbol mark which is characterized according to claim 21 in that before cementing the film—a template coating is applied to the surface of the film with the recorded optical information, which coating weakens the adhesion of these films to one another.
